(19) United States
(12) Patent Application Publication
(10) Pub. No.: US 2026/0066711 A1
(43) Pub. Date: Mar. 5, 2026

(54) Transmitter and Receiver Negotiations for Wireless Power Transfer

(71) Applicant: Apple Inc., Cupertino, CA (US)

(72) Inventors: Wangxin Huang, San Jose, CA (US); David A. Vakshlyak, Milpitas, CA (US)

(21) Appl. No.: 19/263,300

(22) Filed: Jul. 8, 2025

Related U.S. Application Data
(60) Provisional application No. 63/690,676, filed on Sep. 4, 2024.

(51) Int. Cl. H02J 50/80; H02J 7/00; H02J 50/10; H02J 50/90

(52) U.S. Cl. CPC H02J 50/80; H02J 7/42; H02J 7/933; H02J 50/10; H02J 50/90; H02J 2207/20

(57) ABSTRACT

A wireless power transfer system may include a power transmitting device for transferring wireless power to a power receiving device. The power transmitting device can transmit signals to the power receiving device using multiple different inverter switching frequencies. The power transmitting device can establish communications with and transfer wireless power to the power receiving device using a first inverter frequency and can attempt to establish communications with and transfer wireless power to the power receiving device using a second inverter different than the first inverter frequency to optimize charging wattage.

This application claims the benefit of U.S. provisional patent application No. 63/690,676, filed Sep. 4, 2024, which is hereby incorporated by reference herein in its entirety.

### FIELD

This relates generally to power systems, including wireless power transfer systems for charging electronic devices.

### BACKGROUND

In a wireless charging system, a wireless power transmitting device such as a charging puck can transmit wireless power to a wireless power receiving device such as a battery-powered, portable electronic device. The wireless power transmitting device has a coil that produces electromagnetic flux. The wireless power receiving device has a coil and a rectifier that uses electromagnetic flux produced by the transmitter to generate direct-current power that is used to power electrical loads in the battery-powered, portable electronic device. The wireless power transmitting device can transmit wireless power at one or more frequencies.

### SUMMARY

An aspect of the disclosure provides a power transmitting device that includes a wireless power transfer coil configured to transmit wireless power to a power receiving device, an inverter configured to drive alternating current (AC) signals through the wireless power transfer coil, and control circuitry coupled to the inverter. The control circuitry is configured to: transmit a first digital ping to the power receiving device while the inverter is operating at a first frequency; receive a message from the power receiving device indicating that the power receiving device is ready to proceed with a subsequent stage of wireless power transfer; and after receiving the message, adjust the inverter to operate at a second frequency and transmit one or more additional digital pings while the inverter is operating at the second frequency. After transmitting the one or more additional digital pings, the control circuitry is further configured to: adjust the inverter to operate at the first frequency and transmit a second digital ping while the inverter is operating at the first frequency; and continue to transmit, while the inverter is operating at the first frequency, wireless power to the power receiving device using the wireless power transfer coil, until a battery level of the power receiving device exceeds a state of charge threshold.

An aspect of the disclosure provides a power receiving device that includes a wireless power transfer coil configured to receive wireless power from a power transmitting device, a rectifier coupled to the wireless power transfer coil and configured to output a rectified voltage, a battery configured to receive the rectified voltage from the rectifier, and control circuitry coupled to the wireless power transfer coil. The control circuitry is configured to: receive a first digital ping, modulated at a first frequency, from the power transmitting device; transmit a message to the power transmitting device indicating that the power receiving device is ready to proceed with a subsequent stage of wireless power transfer; after transmitting the message, receive one or more additional digital pings, modulated at the second frequency, from the power transmitting device; after receiving the one or more additional digital pings, receive a second digital ping, modulated at the first frequency, from the power transmitting device; and after receiving the second digital ping, continue to receive wireless power, modulated at the first frequency, from the power transmitting device using the wireless power transfer coil, until a battery level of the battery exceeds a state of charge threshold.

An aspect of the disclosure provides a method of operating a power transmitting device, where the method includes: detecting a power receiving device being disposed on a charging surface of the power transmitting device; transmitting a first digital ping using a first frequency to the power receiving device; receiving a message from the power receiving device indicating that the power receiving device is ready to proceed with a subsequent stage of wireless power transfer; after receiving the message, transmitting one or more additional digital pings using a second frequency greater than the first frequency; after transmitting the one or more additional digital pings, transmitting a second digital ping using the first frequency to the power receiving device; and after transmitting the second digital ping, transmitting wireless power using the first frequency to the power receiving device until a battery level at the power receiving device exceeds a state of charge threshold.

### BRIEF DESCRIPTION OF THE DRAWINGS

FIG. 1 is a diagram of an illustrative wireless power transfer system that includes a wireless power transmitting device and a wireless power receiving device in accordance with some embodiments.

FIG. 2 is a diagram showing data communications circuitry within a wireless power transmitting device and a wireless power receiving device in accordance with some embodiments.

FIG. 3 is a flowchart of illustrative steps for adjusting a wireless power transmitting inverter frequency from a first value to a second value different than the first value in accordance with some embodiments.

FIG. 4 is a flowchart of illustrative steps for performing a number of frequency transition attempts before falling back on a nominal wireless power transmitting inverter frequency in accordance with some embodiments.

FIG. 5 is a flowchart of illustrative steps for operating a wireless power transfer system when a wireless power receiving device is detached from a wireless power transmitting device in accordance with some embodiments.

### DETAILED DESCRIPTION

A wireless power transfer system includes a wireless power transmitting device and a wireless power receiving device. The wireless power transmitting device can transmit wireless power to the wireless power receiving device. Wireless power receiving devices may include electronic devices such as wristwatches, cellular telephones, tablet computers, laptop computers, car buds, battery cases for ear buds and other devices, tablet computer styluses (pencils) and other input-output devices, wearable devices, head-mounted devices, glasses, or other electronic equipment. The wireless power transmitting device may be an electronic device such as a wireless charging mat or puck, a tablet computer or other battery-powered electronic device with wireless power transmitting circuitry, or other wireless power transmitting device. The wireless power receiving devices use the wireless power received from the wireless power transmitting device for powering internal components and for charging an internal battery. Because transmitted wireless power is often used for charging internal batteries, wireless power transmission operations are sometimes referred to as wireless charging operations.

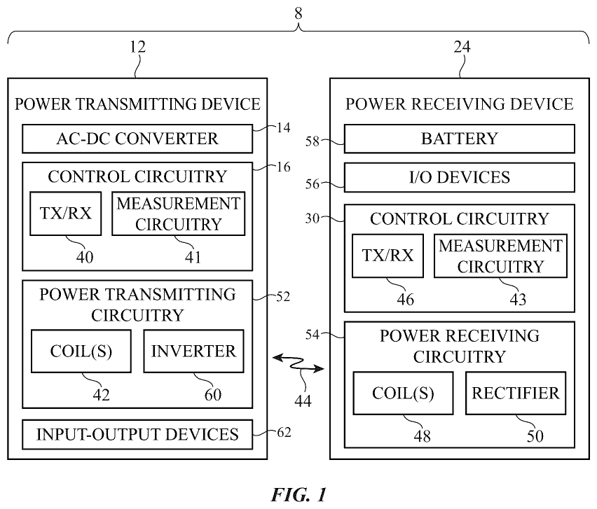

An illustrative wireless power transfer system 8, sometimes referred to as a wireless charging system, is shown in FIG. 1. As shown in FIG. 1, system 8 includes a wireless power transmitting device such as wireless power transmitting device 12 and includes a wireless power receiving device such as wireless power receiving device 24. Wireless power transmitting device 12 can include control circuitry 16, whereas wireless power receiving device 24 can include control circuitry 30. Control circuitry in system 8 such as control circuitry 16 and control circuitry 30 is used in controlling the operation of system 8. Such control circuitry may include processing circuitry associated with microprocessors, power management units, baseband processors, application processors, digital signal processors, microcontrollers, and/or application-specific integrated circuits with processing circuits.

The processing circuitry implements desired control and communications features in devices 12 and 24. For example, the processing circuitry may be used in selecting coils, determining power transmission levels, processing sensor data and other data, processing user input, handling negotiations between devices 12 and 24, sending and receiving in-band and out-of-band data, making measurements, and otherwise controlling the operation of system 8. As another example, the processing circuitry may include one or more processors such as an application processor that is used to run software such as internet browsing applications, voice-over-internet-protocol (VOIP) telephone call applications, email applications, media playback applications, operating system functions, power management functions for controlling when one or more processors wake up, game applications, maps, instant messaging applications, payment applications, calendar applications, notification/reminder applications, etc.

Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in control circuitry 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors such as an application processor, a central processing unit (CPU) or other processing circuitry.

Wireless power transmitting device 12 may be a stand-alone power adapter (e.g., a wireless charging mat or puck that includes power adapter circuitry), may be a wireless charging mat or puck that is coupled to a power adapter or other equipment by a cable, may be a battery-powered electronic device (cellular telephone, tablet computer, laptop computer, removable case, etc.), may be equipment that has been incorporated into furniture, a vehicle, or other system, or may be other wireless power transfer equipment. Illustrative configurations in which wireless power transmitting device 12 is a wireless charging puck or battery-powered electronic device are sometimes described herein as an example.

Wireless power receiving device 24 may be a portable electronic device such as a wristwatch, a cellular telephone, a laptop computer, a tablet computer, an accessory such as an earbud, a tablet computer input device such as a wireless tablet computer stylus (pencil), a battery case, a wearable device, a head-mounted device, glasses, or other electronic equipment. Wireless power transmitting device 12 may be coupled to a wall outlet (e.g., an alternating current power source), may have a battery for supplying power, and/or may have another source of power. Device 12 may have an alternating-current (AC) to direct-current (DC) power converter such as AC-DC power converter 14 for converting AC power from a wall outlet or other power source into DC power. In some configurations, AC-DC power converter 14 may be provided in an enclosure (e.g., a power brick enclosure) that is separate from the enclosure of device 12 (e.g., a wireless charging puck enclosure or battery-powered electronic device enclosure) and a cable may be used to couple DC power from the power converter to device 12. DC power may be used to power control circuitry 16.

During operation, a controller in control circuitry 16 may use power transmitting circuitry 52 to transmit wireless power to power receiving circuitry 54 of device 24. Power transmitting circuitry 52 may have switching circuitry (e.g., inverter circuitry 60 formed from transistors) that is turned on and off based on control signals provided by control circuitry 16 to create AC current signals through one or more wireless power transfer coils 42. Coils 42 may be arranged in a planar coil array (e.g., in configurations in which device 12 is a wireless charging mat) or may be arranged to form a cluster of coils (e.g., in configurations in which device 12 is a wireless charging puck). In some arrangements, device 12 (e.g., a charging mat, pad, puck, battery-powered device, etc.) may have only a single wireless power transfer coil. In other arrangements, wireless charging device 12 may have multiple coils (e.g., two or more coils, 5-10 coils, at least 10 coils, 10-30 coils, fewer than 35 coils, fewer than 25 coils, or other suitable number of coils).

As the AC currents pass through one or more coils 42, the coils 42 produce corresponding electromagnetic field 44 in response to the AC current signals. Electromagnetic field (sometimes referred to as wireless power or wireless power signals) 44 can then induce a corresponding AC current to flow in one or more nearby receiver coils such as coil 48 in power receiving device 24. Rectifier circuitry such as a rectifier 50, which contains rectifying components such as synchronous rectification metal-oxide-semiconductor transistors arranged in a bridge network, can convert the induced AC current flowing through coil 48 into DC voltage signals for powering one or more loads in power receiving device 24 such powering application processors as well as charging a battery in device 24. This principle of wireless power transfer can be referred to as the transmitting and receiving of wireless power or wireless power signals. Coil 48 configured to receive wireless power signals from power transmitting device 12 is thus sometimes referred to herein as a wireless power receiving coil or a wireless power transfer coil.

The DC voltages produced by rectifier 50 can be used in powering an energy storage device such as battery 58 and can be used in powering other components in power receiving device 24. For example, device 24 may include input-output devices 56 such as a display, touch sensor, communications circuits, audio components, sensors, components that produce electromagnetic signals that are sensed by a touch sensor in a tablet computer or other device with a touch sensor (e.g., to provide stylus (pencil) input, etc.), and other components, and these components may be powered by the DC voltages produced by rectifier 50 (and/or DC voltages produced by battery 58 or other energy storage device in device 24). Wireless power transmitting device 12 may also include one or more input-output devices 62 (e.g., input devices and/or output devices of the type described in connection with input-output devices 56) or input-output devices 62 may be omitted (e.g., to reduce device complexity).

Control circuitry 16 in power transmitting device 12 can include transceiver circuitry 40 and measurement circuitry 41. Measurement circuitry 41 can be configured to detect external objects on the charging surface of the housing of device 12 (e.g., on the top of a charging pad or, if desired, to detect objects adjacent to the coupling surface of a charging pad). Measurement circuitry 41 is therefore sometimes referred to as external object measurement circuitry. The housing of device 12 may have polymer walls, walls of other dielectric, metal structures, fabric, and/or other housing wall structures that enclose coil(s) 42 and other circuitry of device 12. The charging surface may be a planer outer surface of the upper housing wall of device 12. Measurement circuitry 41 can detect foreign objects such as coils, paper clips, and other metallic objects and can detect the presence of wireless power receiving devices 24 (e.g., circuitry 41 can detect the presence of one or more coils 48). During object detection and characterization operations, external object measurement circuitry 41 can be used to make measurements on coil(s) 42 to determine whether any devices 24 are present on the charging surface of device 12.

Control circuitry 30 in power receiving device 24 can include transceiver circuitry 46 and measurement circuitry 43. Measurement circuitry 43 may include signal generator circuitry, pulse generator circuitry, signal detection circuitry, and other and/or measurement circuitry (e.g., circuitry of the type described in connection with circuitry 41 in control circuitry 16). Circuitry 41 and/or circuitry 43 may be used in making current and voltage measurements, measurements of transmitted and received power for power transmission efficiency estimates, coil Q-factor measurements, coil inductance measurements, coupling coefficient measurements, and/or other measurements. Based on this information or other information, control circuitry 30 can characterize the operation of devices 12 and 24. For example, measurement circuitry 41 can measure coil(s) 42 to determine the inductance(s) and Q-factor value(s) for coil(s) 42, can measure transmitted power in device 12 (e.g., by measuring the DC voltage powering inverter 60 and the DC current of inverter 60 and/or by otherwise measuring voltages and currents in the wireless power transmitting circuitry 52 of device 12), and can make other measurements on operating parameters associated with other components in device 12. In power receiving device 24, measurement circuitry 43 can measure coil(s) 48 to determine the inductance(s) and Q-factor value(s) for those coil(s), can measure received power in device 24 (e.g., by measuring the output current and output voltage Vrect of rectifier 50 and/or by otherwise measuring voltages and currents in wireless power receiving circuitry 54 of device 24), and can make other measurements on the operating parameters associated with other components in device 24.

During wireless power transfer operations, wireless transceiver (TX/RX) circuitry 40 can use one or more coils 42 to transmit in-band signals to wireless transceiver circuitry 46 that are received by wireless transceiver circuitry 46 using coil(s) 48. Suitable modulation schemes may support communications between power transmitting device 12 and power receiving device 24. With one illustrative configuration, frequency-shift keying (FSK) can be used to convey in-band data from device 12 to device 24 and amplitude-shift keying (ASK) can be used to convey in-band data from device 24 to device 12. As another example, FSK can be used to convey data in both directions between devices 12 and 24. As another example, ASK can be used to convey data in both directions between devices 12 and 24. Wireless power may be conveyed from device 12 to device 24 during these FSK/ASK transmissions. Other types of in-band communications may be used, if desired.

During wireless power transfer operations, power transmitting circuitry 52 supplies AC drive signals to one or more coils 42 at a given power transmission frequency (sometimes referred to as a carrier frequency, power carrier frequency, drive frequency, inverter frequency, inverter modulation frequency, or inverter switching frequency). The power carrier (inverter) frequency may be, for example, a predetermined frequency of about 125 kHz, about 128 kHz, about 200 kHz, about 326 kHz, about 360 kHz, at least 80 kHz, at least 100 kHz, less than 500 kHz, less than 300 kHz, 1.78 MHz, 13.56 MHz, or other suitable wireless power frequency. Devices operating under the Qi wireless charging standard established by the Wireless Power Consortium (WPC) generally operate between 110-205 kHz, between 80-300 kHz, or between 300-400 kHz. In some configurations, the power transmission frequency may be negotiated during startup communications between devices 12 and 24. In other configurations, the power transmission frequency can be fixed.

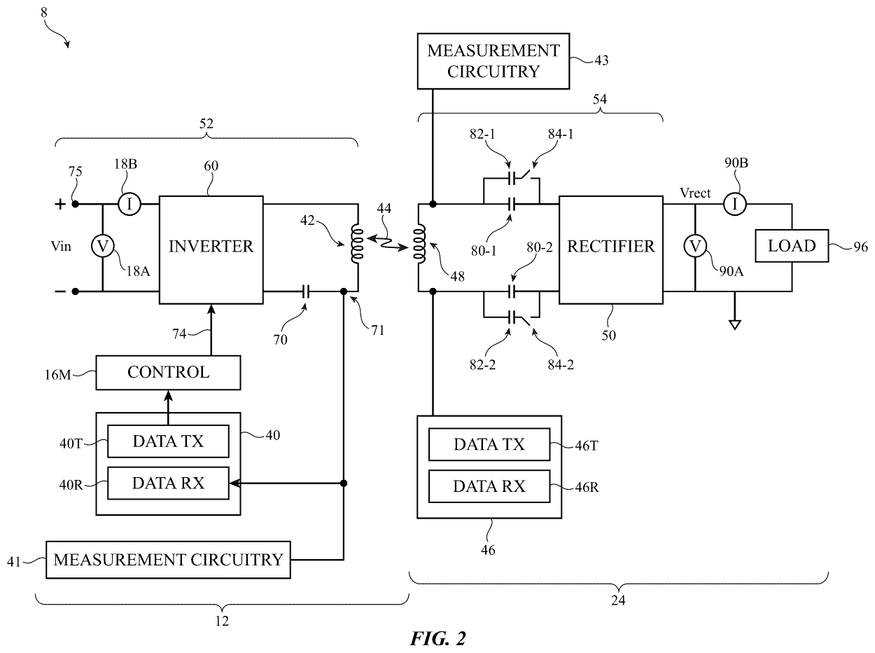

FIG. 2 is a diagram showing wireless power transmitting and receiving circuitry and associated wireless data transceiver (communications) circuitry in power transmitting device 12 and power receiving device 24. Power transmitting circuitry 52 of device 12 may use inverter 60 or other driver for producing wireless power signals that are transmitted through an output circuit having one or more coil(s) 42 and capacitors such as capacitor 70. A single coil 42 is shown in the example of FIG. 2, but multiple coils 42 may be used, if desired.

Inverter 60 can be configured to receive an input voltage Vin from a power adapter. Input voltage Vin received at a voltage input 75 of PTX device 12 from a separate power adapter (e.g., an external wall power adapter) is sometimes referred to and defined herein as a “power transmitting device input voltage.” In certain embodiments, a DC-DC converter (e.g., a boost converter) within power transmitting device 12 or the external power adapter can help efficiently boost Vin to a higher voltage level. If desired, power transmitting device 12 may include one or more voltage sensors such as voltage sensor 18A and one or more current sensors such as current sensor 18B. Voltage sensor 18A can be configured to measure a voltage level of input voltage Vin, whereas current sensor 18B can be configured to measure a current level flowing into inverter 60 via input terminal 75. The voltage and current sensors 18A and 18B may be used to determine power levels within power transmitting device 12. The specific locations of sensors 18A and 18B (e.g., on the DC sides of inverter 60 in FIG. 2) are merely illustrative. In general, voltage and current sensors 18A and 18B may be positioned at any desired positions within the power transmitting circuitry 52 (e.g., on the AC sides of inverter 60, if desired).

Control signals for inverter 60 are provided by control circuitry 16 at control input 74. During wireless power transfer/transmission operations, transistors in inverter 60 are driven by AC control signals from control circuitry 16 (e.g., controller 16M supplies drive signals for inverter 60 at input 74 at a desired AC drive frequency). This causes the output circuit formed from coil 42 and capacitor 70 to produce alternating-current (AC) electromagnetic field (signals 44) that is received by wireless power receiving circuitry 54 formed from coil 48 in device 24. Rectifier 50 can then convert received power from AC to DC and supply a corresponding direct current (DC) output voltage Vrect for powering load 96 in power receiving device 24 (e.g., for charging battery 58, for powering a display and/or other input-output devices 56, and/or for powering other circuitry in load 96). The output voltage Vrect of rectifier 50 is sometimes referred to herein as a rectified voltage.

If desired, power receiving device 24 may include one or more voltage sensors such as voltage sensor 90A and one or more current sensors such as current sensor 90B coupled to output terminals of rectifier 50. Voltage sensor 90A can be configured to measure a voltage level of rectifier output voltage Vrect, whereas current sensor 90B can be configured to measure a current level flowing from the output terminals of rectifier 50 into load 96. The voltage and current sensors 90A and 90B may be used to determine power levels within power receiving device 24. The specific locations of sensors 90A and 90B (e.g., on the DC sides of rectifier 50 in FIG. 2) are merely illustrative. In general, voltage and current sensors 90A and 90B may be positioned at any desired positions within the power receiving circuitry 54 (e.g., on the AC sides of rectifier 50, if desired).

Wireless power transfer coil 48 of power receiving device 24 can be coupled to one or more capacitors. In the example of FIG. 2, coil 48 can have a first terminal coupled to rectifier 50 via capacitor 80-1 and can have a second terminal coupled to rectifier 50 via capacitor 80-2. Capacitor 82-1 can selectively be coupled in parallel with capacitor 80-1 via an associated switch 84-1. When switch 84-1 is activated (i.e., turned on), capacitors 80-1 and 82-1 can be coupled together in parallel. When switch 84-1 is deactivated (i.e., turned off), capacitor 82-1 will be switched out of use. The term “activate” with respect to a switch (or transistor) may refer to or be defined herein as an action that places the switch in an “on” or low-impedance state such that the two terminals of the switch are electrically connected to conduct current. Activating a switch can sometimes be referred to as turning on or closing a switch. The term “deactivate” with respect to a switch (or transistor) may refer to or be defined herein as an action that places the switch in an “off” or high-impedance state such that the two terminals of the switch/transistor are electrically disconnected with minimal leakage current. Deactivating a switch can sometimes be referred to as turning off or opening a switch.

At the other end, capacitor 82-2 can selectively be coupled in parallel with capacitor 80-2 via an associated switch 84-2. When switch 84-2 is activated (i.e., turned on), capacitors 80-2 and 82-2 can be coupled together in parallel. When switch 84-2 is deactivated (i.e., turned off), capacitor 82-2 will be switched out of use. The state of switches 84-1 and 84-2 can be controlled by data transceiver 46 or other control circuitry within power receiving device 24. In some embodiments, the state of switches 84-1 and 84-2 can be a function of a data communications or power transfer mode that is currently employed by system 8 to convey data packets or wireless power between devices 12 and 24. The example of FIG. 2 in which coil 48 is coupled to four capacitors 80-1, 82-1, 80-2, and 82-2 is illustrative. In other embodiments, coil 48 can be selectively coupled to two or more capacitors, three to ten capacitors, or more than ten capacitors. Capacitors 82-1 and 82-1, when switched into use, can alter the impedance of power receiving circuitry 54 and are thus sometimes referred to as impedance adjustment components.

During wireless power transfer operations, while power transmitting circuitry 52 in device 12 is driving AC signals into coil 42 to produce signals 44 at the power transmission frequency, wireless data transceiver circuitry 40 in device 12 can use frequency shift keying (FSK) modulation to modulate the power transmission frequency of the driving AC signals and thereby modulate the frequency of signals 44. As shown in FIG. 2, FSK modulator 40T may modulate the power transmission frequency that is being supplied by controller 16M to input 74 of inverter 60. Operated in this way, FSK data is transmitted in-band from device 12 to device 24. This data can be received in power receiving device 24 by using FSK demodulator 46R (data receiver RX) to perform FSK demodulation operations.

In power receiving device 24, coil 48 is used to receive signals 44. Power receiving circuitry 54 in device 24 uses the received signals on coil 48 and rectifier 50 to produce DC power. At the same time, wireless transceiver circuitry 46 (e.g., FSK demodulator 46R) in device 24 uses FSK demodulation to extract the transmitted in-band data from signals 44. This approach allows FSK data (e.g., FSK data packets) to be transmitted in-band from device 12 to device 24 with coils 42 and 48 while wireless power is simultaneously being conveyed from device 12 to device 24 via coils 42 and 48. Transceiver circuitry 46 may be coupled to coil 48 (e.g., via one or more capacitors). Measurement circuitry 43 may also be coupled to coil 48 or some other node in power receiving circuitry 54 to make impedance measurements, impulse response measurements, or other desired measurements for external object detection.

Such in-band communications between device 24 and device 12 can also use ASK modulation and demodulation techniques. Wireless transceiver circuitry 46 includes ASK modulator 46T coupled to coil 48 to modulate the impedance of power receiving circuitry 54 (e.g., to adjust the impedance at coil 48). This, in turn, modulates the amplitude of signals 44 and the amplitude of the AC signals passing through coil 42. ASK demodulator 40R monitors the amplitude of the AC signal passing through coil 42 and, using ASK demodulation, extracts the transmitted in-band data from these signals that was transmitted by wireless transceiver circuitry 46. ASK demodulator 40R may be coupled to a node 71 between coil 42 and capacitor 70 or may be coupled to some other node in power transmitting circuitry 52. Similarly, measurement circuitry 41 may optionally be coupled to node 71 or some other node in power transmitting circuitry 52 to make impedance measurements, impulse response measurements, or other desired measurements for external object detection. The use of ASK communications allows ASK data bits (e.g., ASK data packets) to be transmitted in-band from device 24 to device 12 via coils 48 and 42 while wireless power is simultaneously being conveyed from device 12 to device 24 via coils 42 and 48. Data transceiver 40 of power transmitting device and data transceiver 46 of power receiving device 24 that are used for conveying in-band data packets via wireless power transfer coils 42 and 48 are therefore sometimes referred to herein as data “communication(s)” transceiver circuitry.

Power transmitting device 12 can be configured to transfer wireless power to power receiving device 24 in accordance with one or more charging modes. Power transmitting device 12 can be operable in at least first and second charging modes. In the first charging (power transfer) mode, power transmitting device 12 can employ power transmitting circuit 52 to transmit wireless power when inverter 60 is operating at a first power carrier frequency F1 (e.g., inverter 60 is driving AC signals at frequency F1). Power carrier frequency F1 is thus sometimes referred to and defined herein as a first “inverter” frequency. In the second charging (power transfer) mode, power transmitting device 12 can employ power transmitting circuit 52 to transmit wireless power when inverter 60 is operating at a second power carrier frequency F2 different than F1 (e.g., inverter 60 is driving AC signals at a different frequency F2). Power carrier frequency F2 is thus sometimes referred to and defined herein as a second “inverter” frequency. Inverter frequencies F1 and F2 can sometimes be referred to herein collectively as wireless power transmitting inverter frequencies.

As an example, the first inverter frequency F1 may be less than the second inverter F2. In such a scenario, the first charging mode can be considered a slow(er) power transfer mode, whereas the second charging mode can be considered a fast(er) power transfer mode relative to the first charging mode. The example above in which system 8 is operable in two different charging modes with two different charging speeds (wattage) is illustrative. In general, wireless power transfer system 8 can be configured to support three or more power transfer modes with different charging speeds, four or more power transfer modes with different charging speeds, five or more power transfer modes with different charging speeds, six to ten power transfer modes with different charging speeds, or more than ten power transfer modes with different charging speeds (wattage).

To switch between different the charging modes, power receiving device 24 can output a frequency transition request, which can subsequently direct power transmitting device 24 to transition to a charging mode that uses a different inverter frequency. In certain situations, such as when devices 12 and 24 are not properly aligned (e.g. if the wireless power transfer coils 42 and 48 are misaligned or if the housings of devices 12 and 24 are misaligned), system 8 can inadvertently hop back and forth between the different charging modes, which can result in suboptimal wireless power transfer efficiency.

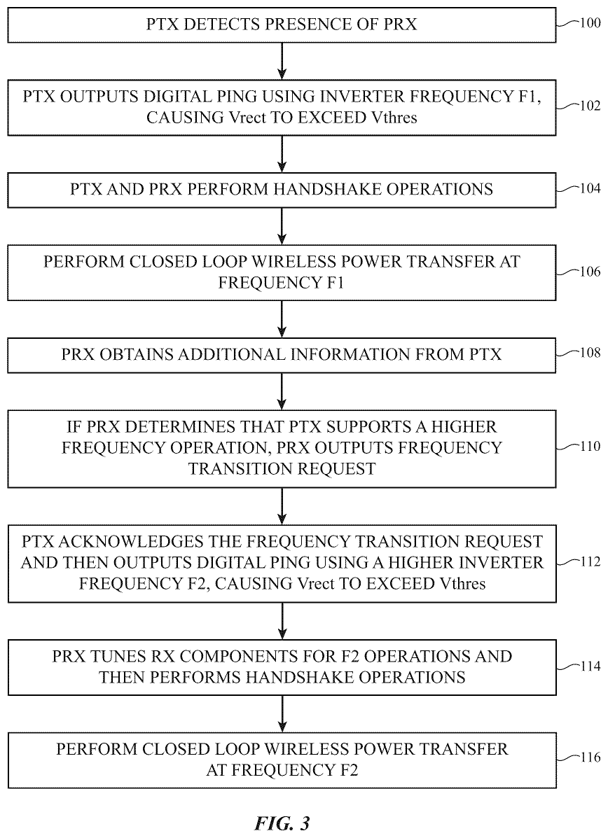

In accordance with some embodiments, frequency transition techniques are provided that mitigate such wireless power transfer inefficiencies that can arise when devices 12 and 24 are misaligned or detached from one each other. FIG. 3 is a flowchart of illustrative steps for adjusting the wireless power transmitting inverter frequency of power transmitting device 12. During the operations of block 100, power transmitting device 12 can operate in a foreign object detection (FOD) mode and can detect the presence of a power receiving device 24 on its charging surface. For example, power transmitting device 12 may use low-power external object detection or analog pings to detect the presence of a foreign object. As another example, power transmitting device 12 may perform impedance measurements, impulse response measurements, or other suitable foreign object detection schemes to detect when device 24 has been placed on the charging surface of device 12.

After power transmitting device 12 detects a potential power receiving device 24 on its charging surface, device 12 can output, during the operations of block 102, a digital ping to communicate with device 24. Digital pings are a type of ping signals. “Digital pings” may refer to and be defined herein as signals having longer pulses than the external object detection analog pings and having sufficient energy to activate or wake power receiving device 24 (e.g., a digital ping has sufficient bandwidth to support in-band communications between devices 12 and 24). For example, FSK and/or ASK data packets may be conveyed between devices 12 and 24 during digital ping operations. These in-band communications can be modulated at some inverter frequency.

During the operations of block 102, power transmitting device 12 can output a digital ping while the inverter 60 is operating at inverter frequency F1. For example, inverter frequency can be equal to about 125 kHz, about 128 kHz, about 200 kHz, about 326 kHz, about 360 kHz, at least 80 kHz, at least 100 kHz, less than 500 kHz, less than 300 kHz, 1.78 MHz, 13.56 MHZ, 110-205 kHz, between 80-300 kHz, between 300-400 kHz, or other suitable wireless power frequency or frequency range. The digital ping, sometimes referred to as a digital ping signal, can be received at power receiving device 24. Such digital ping signal received at coil 48 can result in AC current to flow through coil 48, which can cause rectifier 50 to drive output voltage Vrect high(er). When the rectifier output voltage Vrect exceeds a rectifier output threshold Vthres, one or more load components 96 can power (wake) up, including waking up data communications circuitry 46.

During the operations of block 104, devices 12 and 24 can perform one or more handshake operations. For example, power receiving device 24 can send one or more startup or identification packets providing information such as its power requirements, supported charging standards, and/or other wireless power transfer parameters. Power transmitting device 12 can also send one or more startup or identification packets providing information such as its power capabilities, supported charging standards, and/or other wireless power transfer characteristics to device 24. Based on the exchanged (identification) information, power transmitting device 12 can perform power negotiations operations with power receiving device 24 (e.g. so that device 12 can determine a suitable output for safely charging device 24). If desired, other handshaking, negotiation, or authentication operations can also be performed during block 104.

Subsequently, during the operations of block 106, power transmitting device 12 can optionally begin transmitting wireless power to power receiving device 24. In other words, power transmitting device 12 can be configured to operate in an “active” wireless power transfer mode. During the active wireless power transfer mode, power transmitting device 12 can transmit wireless power while inverter 60 is modulating signals at inverter frequency F1 (e.g., at the same carrier frequency previously used for transmitting the digital ping during block 102). During the active wireless power transfer mode, device 12 may concurrently perform in-band communications with device 24 (e.g., device 12 may use data transmitter 40T to transmit FSK packets to data receiver 46R, whereas device 24 may use data transmitter 46T to transmit ASK packets to data receiver 40R while wireless power is being transferred from device 12 to device 24). During the active wireless power transfer mode, power receiving device 24 can sometimes output a request for dynamically adjust the output power level of device 12 (e.g., by outputting control error packets or other power control request packets to device 12 for adjusting input voltage Vin). Such type of wireless power transfer operation in which device 24 can continuously negotiate desired power levels with device 12 is sometimes referred to as a “closed loop” wireless power transfer.

During the active wireless power transfer mode, power receiving device 24 can optionally obtain additional information from power transmitting device 12 (see, e.g., operations of block 108). As an example, power receiving device 24 can receive information such as a country code from power transmitting device 12. The country code can indicate a location reflecting where system 8 is currently operating. For instance, a country code having a first value might indicate that system 8 is currently located in the United States; a country code having a second value different than the first value might indicate that system 8 is currently located in a European country; and a country code having a third value different than the first and second values might indicate that system 8 is currently located in an Asian country. Additional or alternatively, power receiving device 24 can receive information such as an input voltage limit from power transmitting device 12. The input voltage limit can represent a maximum input voltage Vin that is supported by device 12 (see FIG. 2). If desired, power receiving device 24 can obtain one or more other wireless power transfer parameter(s) from power transmitting device 12 during block 108.

During the operations of block 110, power receiving device 24 can perform an action based on the information received during block 108 and/or block 104. As an example, power receiving device 24 can analyze the received country code and/or other power capabilities information received during block 104 and/or block 108 and determine whether power transmitting device 12 can support wireless power transfer using a different inverter frequency. In response to determining that device 12 can support active wireless power transfer using another inverter frequency, power receiving device 24 can output a frequency transition request (packet) to power transmitting device 12 (e.g., via in-band communications). A “frequency transition” request can refer to and be defined herein as a request to adjust an operating frequency such as the wireless power transmission inverter frequency at device 12. The frequency transition request can include information designating a target inverter frequency F2 that is different than the current inverter frequency F1. This example in which power receiving device 24 transmits a frequency transition request to device 12 is illustrative. More generally, power receiving device 24 can transmit a message indicating that device 24 is ready to proceed with a subsequent (further) stage of wireless power transfer (e.g., a message indicating to power transmitting device 24 that it is ready to receive signals at a different carrier frequency).

During the operations of block 112, power transmitting device 12 can receive the frequency transition request (or other message indicating that device 24 is ready to proceed with further stages of wireless power transfer) from device 24 and respond by outputting a corresponding acknowledgement packet back to device 24. Such type of acknowledgement packet is sometimes referred to herein as a frequency transition acknowledgement (ACK) response. After sending the frequency transition ACK response, power transmitting device 12 can terminate current the digital ping modulated at frequency F1. After receiving the frequency transition ACK response packet from device 12, the rectifier output voltage Vrect within power receiving device 24 can fall to a low voltage, marking an end of the active wireless power transfer operation.

Power transmitting device 12 can then output, during the operations of block 112, a digital ping while the inverter 60 is operating at an adjusted inverter frequency F2 in accordance with the received frequency transition request. In general, the adjusted inverter frequency F2 can be greater than F1 or less than F1 and can be equal to about 125 kHz, about 128 kHz, about 200 kHz, about 326 kHz, about 360 kHz, at least 80 kHz, at least 100 kHz, less than 500 kHz, less than 300 kHz, 1.78 MHz, 13.56 MHz, 110-205 kHz, between 80-300 kHz, between 300-400 kHz, or other suitable wireless power frequency or frequency range. Device configurations in which F2 is greater than F1 are sometimes described herein as an example.

Wireless power transfer using higher inverter (power carrier) frequencies generally provide greater charger wattage. Thus, wireless power transfer using inverter frequency F1 can sometimes be referred to herein as a “low(er)-wattage” charging mode, whereas wireless power transfer using a greater inverter frequency F2 can sometimes be referred to herein as a “high(er)-wattage” charging mode. System 8 can support more than two different charging wattages. Modes with higher charging wattage can provide faster charging speeds. The digital ping output during block 112 can be received at power receiving device 24. Such digital ping signal received at coil 48 can result in AC current to flow through coil 48, which can cause rectifier 50 to drive output voltage Vrect high(er). When the rectifier output voltage Vrect exceeds a rectifier output threshold Vthres, one or more load components 96 can power (wake) up, including waking up data communications circuitry 46.

During the operations of block 114, power receiving device 24 can be configured to adjust one or more components in the power receiving circuitry in preparation for wireless power transfer and/or in-band communications at inverter frequency F2. For example, power receiving device 24 can, using control circuitry 30 (see FIG. 1), deactivate switches 84-1 and 84-2 during block 114 to switch capacitors 82-1 and 82-2 out of use. Switches 84-1 and 84-2 might be activated by default, such as during operations when signals modulated at inverter frequency F1 are being conveyed between devices 12 and 24. This is merely illustrative. In other embodiments, switches 84-1 and 84-2 might be deactivated by default and can be activated during the operations of block 114 to selectively couple capacitors 82-1 and 82-2 in parallel with capacitors 80-1 and 80-2, respectively. Such type of component tuning is illustrative. If desired, other components coupled to coil 48 can be adjusted or tuned during block 114 in preparation for operation at the updated frequency.

After tuning the components, devices 12 and 24 can perform one or more handshake operations. For example, power receiving device 24 can send a startup or identification packet providing information such as its power requirements, supported charging standards, and/or other wireless power transfer parameters. Power transmitting device 12 can also send one or more startup or identification packets providing information such as its power capabilities, supported charging standards, and/or other wireless power transfer characteristics to device 24. Based on the exchanged (identification) information, power transmitting device 12 can perform power negotiations operations with power receiving device 24 (e.g. so that device 12 can determine a suitable output for safely charging device 24). If desired, other handshaking, negotiation, or authentication operations can also be performed during block 104.

Subsequently, during the operations of block 116, power transmitting device 12 can begin performing closed-loop wireless power transfer to power receiving device 24. During the active wireless power transfer mode of block 116, power transmitting device 12 can transmit wireless power while inverter 60 is modulating signals at inverter frequency F2 (e.g., using the new/target inverter frequency indicated by the frequency transition request). During the active wireless power transfer mode, device 12 may concurrently perform in-band communications with device 24 (e.g., device 12 may use data transmitter 40T to transmit FSK packets to data receiver 46R, whereas device 24 may use data transmitter 46T to transmit ASK packets to data receiver 40R while wireless power is being transferred from device 12 to device 24). Power transmitting device 12 may continue to transfer wireless power to device 24 until a battery level of battery 58 (see FIG. 1) exceeds a first battery threshold. The battery level of battery 58 is sometimes referred to herein as a state of charge or “SOC.” The first battery threshold is thus sometimes referred to as a first state of charge threshold. The first battery threshold can be equal to or represent at least 80% of a full SOC, at least 90% of a full SOC, at least 95% of a full SOC, or 95-100% of a full SOC. The term “full SOC” can refer to a state at which battery 58 is fully (100%) charged.

The operations of FIG. 3 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

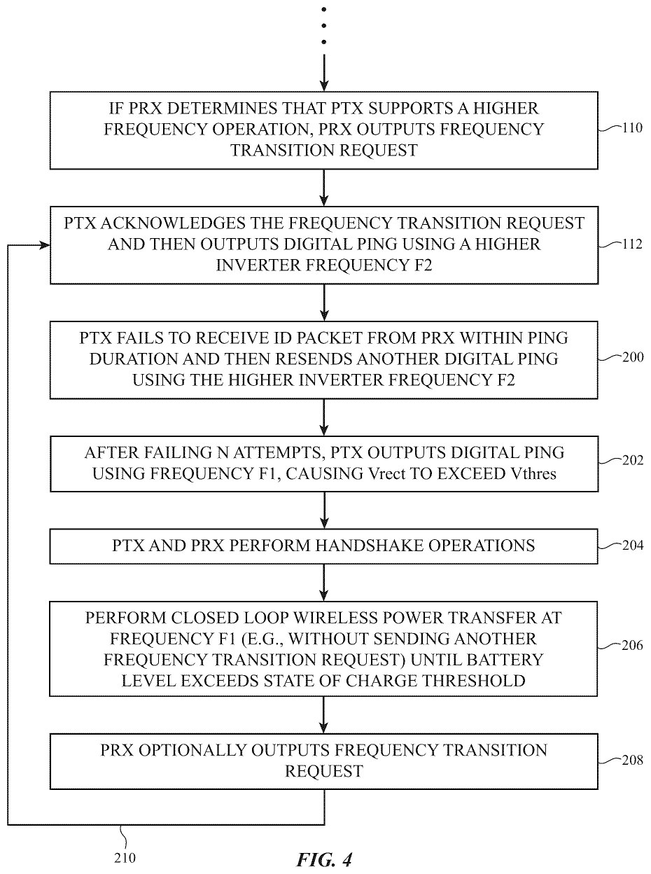

The operations of FIG. 3 illustrate a scenario when system 8 is able to successfully transition from operating at inverter frequency F1 to a different inverter frequency F2. In certain scenarios, such as when devices 12 and 24 are at least partially misaligned (e.g., when the wireless power transfer coils 42 and 48 are not properly aligned or when the housings of devices 12 and 24 are not properly aligned), system 8 may not always be able to successfully change inverter frequencies. FIG. 4 is a flowchart of illustrative steps for operating system 8 when the frequency transition fails. The operations leading up to and including block 110 of FIG. 4 are identical to those already described in connection with blocks 100-110 of FIG. 3 and need not be reiterated to avoid obscuring the present embodiment.

During the operations of block 112 in FIG. 4, power transmitting device 12 can receive the frequency transition request (or other message indicating that device 24 is ready to proceed with further stages of wireless power transfer) from device 24 and respond by outputting a corresponding frequency transition acknowledgement (ACK) packet back to device 24. After sending the frequency transition ACK response, power transmitting device 12 can terminate current the digital ping modulated at frequency F1. Upon termination of the digital ping, the rectifier output voltage Vrect within power receiving device 24 can fall to a low voltage, marking an end of the active wireless power transfer operation. Subsequently, power transmitting device 12 can output, during the operations of block 112, a digital ping while the inverter 60 is operating at an adjusted inverter frequency F2 in accordance with the received frequency transition request.

Ideally, such as when devices 12 and 24 are properly aligned for optimal wireless power transfer, the rectifier output voltage Vrect at device 24 will rise to a higher voltage level exceeding Vthres, which can cause device 24 to tune one or more components and begin performing handshaking operations with device 12, as described in connection with block 114 of FIG. 3. However, when devices 12 and 24 are not properly aligned and/or in the presence of foreign external objects such as coins, paper clips, or other conductive objects that might interfere with the wireless power transfer operation, the digital ping might not result in Vrect exceeding Vthres. As a result, power receiving device 24 will not begin handshake operations, send any acknowledgement or identification packets, or otherwise respond to device 12. Power transmitting device 12 may output the digital ping for a certain digital ping duration to wait for a response from device 24. For example, the digital ping duration can be less than 20 ms (millisecond), less than 30 ms, less than 40 ms, less than 50 ms, less than 100 ms, 10-20 ms, 20-50 ms, 50-100 ms, 100-500 ms, less than one second, or other suitable ping duration.

If power transmitting device 12 fails to receive any response from device 24 during the digital ping duration, power transmitting device 12 can terminate the digital ping and wait for a silent period before sending another digital ping (see operations of block 200). Power transmitting device 12 does not output any in-band signals to device 24 during the silent period. After the silent period, power transmitting device 12 can attempt again to communicate with device 24 by sending a second digital ping while the inverter 60 is operating at the adjusted inverter frequency F2. Power transmitting device 12 may output the second digital ping for the digital ping duration to wait for a response from device 24. If power transmitting device 12 fails to receive any response from device 24 during the digital ping duration of the second digital ping, power transmitting device 12 can terminate the second digital ping and wait for a silent period before sending another digital ping.

Power transmitting device 12 can be configured to make N total attempts at communicating with device 24 using the higher inverter frequency F2 (e.g., by sending N additional digital pings using inverter frequency F2). Here, N can be at least 2, 2-5, 5-10, 10-20, 20-50, 50-100, more than 100, or other integer value. The N additional digital pings modulated at frequency F2 can be received by power receiving device 24, but such digital pings being modulated at the higher frequency F2 might not be able to cause rectifier 50 to drive Vrect to a high voltage level, such as when devices 12 and 24 are not properly aligned.

If power transmitting device 12 fails to establish communications with device 24 after N digital ping attempts, power transmitting device can fall back to outputting a digital ping while the inverter 60 is operating at the lower (nominal) inverter frequency F1, as shown by the operations of block 202. Here, the digital ping being modulated at the lower carrier frequency might be able to finally cause rectifier 50 to drive output voltage Vrect high(er) to exceed rectifier output threshold Vthres, thereby waking up one or more load components 96, including waking up data communications circuitry 46. In this example, a digital ping at the lower frequency F1 might be powerful enough to wake up power receiving device 24 (even when there might be some misalignment between devices 12 and 24), whereas digital pings at the higher frequency F2 might be too weak to wake up device 24.

During the operations of block 204, devices 12 and 24 can perform one or more handshake operations. For example, power receiving device 24 can send a startup or identification packet providing information such as its power requirements, supported charging standards, and/or other wireless power transfer parameters. Based on the exchanged information, power transmitting device 12 can perform power negotiations operations with power receiving device 24 (e.g. so that device 12 can determine a suitable output for safely charging device 24). If desired, other handshaking, negotiation, or authentication operations can also be performed during block 204.

Subsequently, during the operations of block 206, power transmitting device 12 can optionally begin to perform closed-loop wireless power transfer to power receiving device 24. During the active wireless power transfer mode of block 206, power transmitting device 12 can transmit wireless power while inverter 60 is modulating signals at the nominal (lower) inverter frequency F1. During the active wireless power transfer mode, device 12 may concurrently perform in-band communications with device 24 (e.g., device 12 may use data transmitter 40T to transmit FSK packets to data receiver 46R, whereas device 24 may use data transmitter 46T to transmit ASK packets to data receiver 40R while wireless power is being transferred from device 12 to device 24). Power transmitting device 12 can remain in the active wireless power transfer mode using inverter frequency F1 (e.g., continue to transmit wireless power while the inverter is operating at F1) without sending another frequency transition request to device 24, until a battery level of power receiving device 24 exceeds a certain state of charge threshold. During this time, power transmitting device 12 can forego adjustment of the inverter to operate at frequency F2 (e.g., so that the inverter will remain operating at frequency F1). For instance, power transmitting device 12 can forego transmission of further digital pings while the inverter remains operating at frequency F1 during block 206. At the other end, power receiving device 24 can also forego transmission of any frequency transition request or message indicating that device 24 is ready to proceed with subsequent/further stages of wireless power transfer until its battery level exceeds the state of charge threshold.

If desired, power receiving device 24 can optionally output a frequency transition request or other message (see operations of block 208). For example, data transmitter 46T can send a frequency transition request (e.g., a packet requesting power transmitting device 12 to switch from operating using inverter frequency F1 to using inverter frequency F2) or a message indicating that device 24 is ready to proceed with subsequent/further stages of wireless power transfer after charging for a period of time (e.g., after transferring wireless power during block 206 for at least 50 ms, at least 100 ms, 100-500 ms, 500-999 ms, at least one second, 1-5 seconds, 5-10 seconds, or other charging duration), after detecting that the battery level exceeds a second battery (state of charge or “SOC”) threshold, and/or after some other triggering event. The second SOC threshold might be less than the first SOC threshold described above in connection with block 116 of FIG. 3. The second SOC threshold can be equal to or represent at least 0.5% of a full SOC, at least 1% of a full SOC, at least 2% of a full SOC, 1-5% of a full SOC, or other SOC threshold level. A renewed attempt to transition to the higher inverter frequency charging mode can help improve the charging speed. After outputting the frequency transition request to operate at inverter frequency F2, processing can loop back to block 112 (of FIG. 3 or FIG. 4), as shown by path 210.

The operations of FIG. 4 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

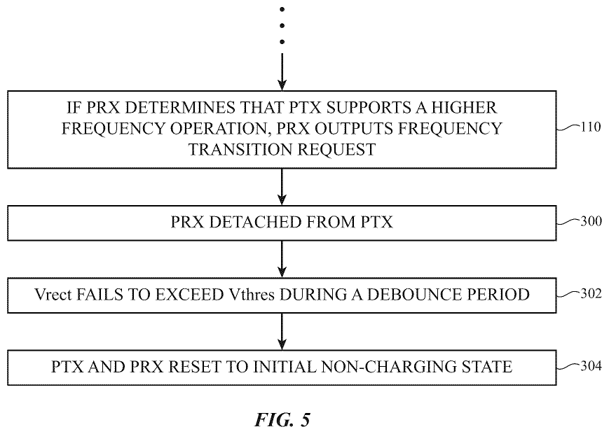

The operations of FIGS. 3 and 4 in which system 8 enters the active wireless power transfer mode are illustrative. FIG. 5 is a flowchart of illustrative steps for operating wireless power transfer system 8 in a scenario that does not result in wireless power transfer. The operations leading up to and including block 110 of FIG. 5 are identical to those already described in connection with blocks 100-110 of FIG. 3 and need not be reiterated to avoid obscuring the present embodiment.

During the operations of block 300 in FIG. 5, power transmitting device 12 can determine whether power receiving device 24 remains attached to its charging surface. For example, power transmitting device can include a magnetic sensor such as a magnetometer. The magnetic sensor can be included as part of input-output devices 62 shown in FIG. 1, as part of measurement circuit 41 shown in FIGS. 1 and 2, or as part of control circuitry 16. The magnetometer can be, for example, a Hall effect sensor, a rotating coil magnetometer, a magneto-resistive sensor, a fluxgate sensor, a microelectromechanical systems magnetic field sensor, or other types of magnetic sensors. In some embodiments, the magnetometer can be a multiple-axis magnetic sensor configured to decipher the polarity and/or orientation of attachment.

The magnetic sensor may monitor or measure a magnetic field at the charging surface of power transmitting device 12. When power receiving device 24 is attached to or otherwise disposed on the charging surface of power transmitting device 12, the magnetic sensor may measure a first amount of magnetic field that exceeds a magnetic field threshold. When power receiving device 24 is detached from or otherwise removed from the charging surface of power transmitting device 12, the magnetic sensor may measure a second amount of magnetic field that is below the magnetic field threshold. During the operations of block 300, power receiving device 24 may be detached from the charging surface of power transmitting device 12, whether intentionally or inadvertently by some action of a user of system 8. Such detachment can be detected by the magnetic sensor of power transmitting device 12. If power transmitting device 12 determines that device 24 is detached or otherwise removed from its charging surface, power transmitting device 12 will not output any additional digital pings.

In accordance with some embodiments, a charging status indicator debounce scheme is used by power receiving device 24 to avoid undesired flickering of a charging status indicator. During charging operations, power receiving device 24 displays a corresponding wireless power charging status indicator (e.g., a green battery icon, text such as “device is currently charging”, or other information indicative of the current charging status of the wireless power receiving device). When power is no longer being transmitted, the charging indicator is removed. A debounce arrangement is used by system 8 to ensure that the state of the charging indicator is not changed too rapidly, which could create an undesirable flicker in the charge indicator or other undesired output.

During charging operations, wireless power transfer may, from time-to-time, be briefly interrupted. For example, a user may move device 24 out of wireless transmission range of the charging surface or device 12 may temporarily pause wireless power transfer to device 24 to allow device 12 to perform measurement operations with measurement circuitry 41 and/or to allow device 12 to perform other operations while wireless signals are interrupted briefly (e.g., for a fraction of a second to a few seconds or other suitable wireless power transfer interruption period). If the status indicator is removed during each pause during wireless power transmission, the status indicator can flicker, which may confuse the user and lead the user to erroneously believe that charging operations are not proceeding normally. With the debounce scheme, removal of the status indicator is inhibited for a debounce period (e.g., a period of about 1.5 to 3 seconds, at least 1 second, less than 5 seconds, or other suitable time period), thereby preventing undesired flickering in the charging status indicator.

Here, after detecting that power receiving device 24 has been detached from its charging surface, power transmitting device 12 may continue to monitor for the presence of device 24 for the debounce period before removing the charging status indicator (see operations of block 302). Device 12 may be configured to prevent transmission of additional digital pings at inverter frequency F2 in response to determining that device 24 has been detached from its charging surface. Since power transmitting device 12 will not output any digital pings when no valid external device is present, the rectifier output voltage Vrect in the detached device 24 will also fail to exceed rectifier output threshold Vthres during the debounce period. If devices 12 and 24 are not reattached or otherwise brought back into contact within the debounce period, devices 12 and 24 will each be reset back to an initial non-charging state (see operations of block 304). For instance, power transmitting device 12 can be reset to an initial state for detecting the presence of a power receiving device.

The operations of FIG. 5 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

The foregoing is merely illustrative and various modifications can be made to the described embodiments. The foregoing embodiments may be implemented individually or in any combination.

What is claimed is:

1. A power transmitting device comprising:
a wireless power transfer coil configured to transmit wireless power to a power receiving device;
an inverter configured to drive alternating current (AC) signals through the wireless power transfer coil; and
control circuitry coupled to the inverter and configured to:
transmit a first digital ping to the power receiving device while the inverter is operating at a first frequency;
receive a message from the power receiving device indicating that the power receiving device is ready to proceed with a subsequent stage of wireless power transfer;
after receiving the message, adjust the inverter to operate at a second frequency and transmit one or more additional digital pings while the inverter is operating at the second frequency; and
after transmitting the one or more additional digital pings:
adjust the inverter to operate at the first frequency and transmit a second digital ping while the inverter is operating at the first frequency; and
continue to transmit, while the inverter is operating at the first frequency, wireless power to the power receiving device using the wireless power transfer coil, until a battery level of the power receiving device exceeds a state of charge threshold.

2. The power transmitting device of claim 1, wherein the control circuitry is further configured to:
while continuing to transmit wireless power, with the inverter operating at the first frequency, to the power receiving device until the battery level of power receiving device exceeds the state of charge threshold, forego adjustment of the inverter to operate at the second frequency.

3. The power transmitting device of claim 2, wherein the control circuitry is further configured to forego adjustment of the inverter to operate at the second frequency by foregoing transmitting further digital pings while the inverter is operating at the first frequency.

4. The power transmitting device of claim 1, wherein the message comprises a frequency transition request to adjust the inverter from operating at the first frequency to operating at the second frequency.

5. The power transmitting device of claim 1, wherein the control circuitry is further configured to:
after the battery level of the power receiving device exceeds the state of charge threshold, receive an additional message from the power receiving device indicating that the power receiving device is ready to proceed with a subsequent stage of wireless power transfer; and
in response to receiving the additional message from the power receiving device, adjust the inverter to operate at the second frequency and transmit at least one additional digital ping while the inverter is operating at the second frequency.

6. The power transmitting device of claim 5, wherein the additional message comprises a frequency transition request to adjust the inverter from operating at the first frequency to operating at the second frequency.

7. The power transmitting device of claim 1, wherein the second frequency is greater than the first frequency, and wherein the control circuitry is configured to provide a first wireless power transfer wattage when the inverter is operating at the first frequency and is configured to provide a second wireless power transfer wattage greater than the first wireless power transfer wattage when the inverter is operating at the second frequency.

8. The power transmitting device of claim 1, wherein the control circuitry is further configured to:
after receiving the message, transmit a corresponding acknowledgement to the power receiving device;
determine, with a magnetic sensor, whether the power receiving device has been detached from a charging surface of the power transmitting device; and
prevent transmission of the one or more additional digital pings in response to determining that the power receiving device has been detached from the charging surface.

9. The power transmitting device of claim 1, wherein the one or more additional digital pings comprise a plurality of successive digital pings separated by silent periods during which the power transmitting device does not transmit any signals, via the wireless power transfer coil, to the power receiving device.

10. A power receiving device comprising:
a wireless power transfer coil configured to receive wireless power from a power transmitting device;
a rectifier coupled to the wireless power transfer coil and configured to output a rectified voltage;
a battery configured to receive the rectified voltage from the rectifier; and
control circuitry coupled to the wireless power transfer coil and configured to:
receive a first digital ping, modulated at a first frequency, from the power transmitting device;
transmit a message to the power transmitting device indicating that the power receiving device is ready to proceed with a subsequent stage of wireless power transfer;
after transmitting the message, receive one or more additional digital pings, modulated at the second frequency, from the power transmitting device;
after receiving the one or more additional digital pings, receive a second digital ping, modulated at the first frequency, from the power transmitting device; and
after receiving the second digital ping, continue to receive wireless power, modulated at the first frequency, from the power transmitting device using the wireless power transfer coil, until a battery level of the battery exceeds a state of charge threshold.

11. The power receiving device of claim 10, wherein the control circuitry is further configured to:
forego transmission of an additional message to the power transmitting device indicating that the power receiving device is ready to proceed with a subsequent stage of wireless power transfer until the battery level of the battery exceeds the state of charge threshold.

12. The power receiving device of claim 10, wherein the message comprises a frequency transition request that directs the power transmitting device to adjust an inverter within the power transmitting device from operating at the first frequency to operating at the second frequency.

13. The power receiving device of claim 10, wherein the control circuitry is further configured to:
after the battery level of the power receiving device exceeds the state of charge threshold, transmit an additional message to the power transmitting device indicating that the power receiving device is ready to proceed with a subsequent stage of wireless power transfer; and
after transmitting the additional message, receive at least one additional digital ping, modulated at the second frequency, from the power transmitting device.

14. The power receiving device of claim 10, wherein the second frequency is greater than the first frequency, and wherein the control circuitry is configured to provide a first charging wattage when wireless power received via the wireless power transfer coil is being modulated at the first frequency and is configured to provide a second charging wattage, greater than the first charging wattage, when wireless power received via the wireless power transfer coil is being modulated at the second frequency.

15. The power receiving device of claim 10, wherein the control circuitry is further configured to:
after receiving the second digital ping, selectively tune one or more impedance adjustment components coupled to the wireless power transfer coil.

16. The power receiving device of claim 10, wherein the control circuitry is further configured to:
perform the one or more handshake operations with the power transmitting device by exchanging one or more identification packets with the power transmitting device; and
before transmitting the message to the power transmitting device, obtain information from the power transmitting device that indicates whether the power transmitting device is capable of modulating signals at the second frequency.

17. The power receiving device of claim 16, wherein the information comprises a country code.

18. A method of operating a power transmitting device, comprising:
detecting a power receiving device being disposed on a charging surface of the power transmitting device;
transmitting a first digital ping using a first frequency to the power receiving device;
receiving a message from the power receiving device indicating that the power receiving device is ready to proceed with a subsequent stage of wireless power transfer;
after receiving the message, transmitting one or more additional digital pings using a second frequency greater than the first frequency;
after transmitting the one or more additional digital pings, transmitting a second digital ping using the first frequency to the power receiving device; and
after transmitting the second digital ping, transmitting wireless power using the first frequency to the power receiving device until a battery level at the power receiving device exceeds a state of charge threshold.

19. The method of claim 18, wherein transmitting wireless power using the first frequency to the power receiving device until the battery level at the power receiving device exceeds the state of charge threshold comprises transmitting wireless power while foregoing adjusting an inverter from operating at the first frequency to operating at the second frequency.

20. The method of claim 19, further comprising:
after the battery level of the power receiving device exceeds the state of charge threshold, receiving an additional message from the power receiving device indicating that the power receiving device is ready to proceed with a subsequent stage of wireless power transfer; and
in response to receiving the additional message from the power receiving device, adjusting the inverter to operate at the second frequency and transmit at least one additional digital ping while the inverter is operating at the second frequency.
